(19) United States
(12) Patent Application Publication
(10) Pub. No.: US 2023/0256633 A1
(43) Pub. Date: Aug. 17, 2023

(54) CUTTER MESH STRUCTURE OF ROTARY SHAVER AND PROCESSING METHOD THEREOF

(71) Applicant: Rangpan WU, Zhongshan (CN)

(72) Inventor: Rangpan WU, Zhongshan (CN)

(21) Appl. No.: 18/007,669

(22) PCT Filed: Dec. 17, 2020
(86) PCT No.: PCT/CN2020/137195

§ 371 Date: Dec. 1, 2022

(30) Foreign Application Priority Data
Jun. 19, 2020 (CN) 202010564287.6

(51) Int. Cl. B26B 19/14; B26B 19/38

(52) U.S. Cl. CPC B26B 19/143; B26B 19/384; B26B 19/44

(57) ABSTRACT

A rotary shaver cutter mesh structure includes a cutter mesh body with a raised ring shaving track having outer and inner ring side faces, and a track top surface for connecting the faces, outer and inner hair inlet slots separated from each other in the shaving track, the outer hair inlet slots extend from the outer ring side face to the middle of the shaving track, the inner hair inlet slots extend from the inner ring side face to the middle of the shaving track, and outer and inner hair inlet slots distributed in a circumferential direction, the slots are staggered, and outer flared hair guide openings corresponding to the outer hair inlet slots and being used for guiding hair into the outer hair inlet slots are in a turning joint between the outer ring side face and the track top surface.

### TECHNICAL FIELD

The present invention relates to a cutter mesh structure of a rotary shaver and further relates to a processing method of the cutter mesh structure of the rotary shaver.

### BACKGROUND ART

Currently, since a cutter mesh of an existing rotary shaver needs to collect hair while moving, straight slots are generally provided in a ring shaving track for hair to enter, and the hair is cut by a rotating blade in the shaving track. However, the skin is prone to being squeezed into the straight slot structure. In order to ensure safety and avoid cutting into the skin, the width of the straight slot structure needs to be small, and accordingly hair inlets are small, resulting in difficulties in hair collection. In order to ensure the hair collection effect, straight slots need to be as many as possible. The straight slots are generally distributed in the circumferential direction of the shaving track regularly, evenly, densely, the densely distributed straight slots form separate spacing strips, which may affect the skin feeling. Moreover, the straight slots generally penetrate from an outer ring side face of the shaving track to an inner ring side face, forming through slots transversely penetrating through the shaving track, so that hair may be collected from the outer ring side face and the inner ring side face of the shaving track, thereby improving the hair collection efficiency. For example, a cutter mesh structure shown in the patent CN201910929923.8 has an inner shaving track and an outer shaving track, and straight slots of through slot structures are evenly distributed by 360° in the two shaving tracks. Of course, in addition to the straight slots (referred to as hair collection holes in the patent) evenly distributed by 360° in the shaving tracks, round hair inlet holes may be provided in tops of the shaving tracks for short hair and hair roots to enter and be cut, as shown by a cutter mesh in the patent CN200480018064.9, where appropriate.

As for the above straight slots of the through slot structure, after hair enters one straight slot, one case is that the rotating blade rotates to the straight slot and cuts off the hair before the hair runs out of the straight slot, and the other case is that the hair has run out of the straight slot before the rotating blade rotates to the straight slot, which results in hair leakage and affects the shaving efficiency. In addition, since the width of a cutting edge of the rotating blade is generally smaller than an inner cavity of the shaving track, reserving gaps between the rotating blade and inner and outer side walls of the inner cavity, in the case that hair enters from one end of a straight slot and runs out from the other end before being cut by the rotating blade, hair may be pulled due to limitation of a sharp inner edge of a straight slot wall and small space, resulting in skin pain and affecting the comfort of shaving.

Of course, in order to avoid hair leakage, that is, hair enters straight slots and then runs out of the straight slots, straight slots of some cutter meshes do not adopt through slot structures, but penetrate from the outer ring side face transversely to the inside by a certain distance and then terminate instead of penetrating through the inner ring side face, and then a cutting area of the rotating blade covers termination portions of the straight slots. In this way, when hair enters a straight slot and runs to the bottom, the hair may stop at the termination position for a period of time instead of running out before the rotating blade rotates to the straight slot, and may be cut after the quickly rotating blade reaches the straight slot, which improves cutting efficiency to a certain extent but sacrificing the effect of collecting hair from the inner ring side face.

Although rotary shaver technology is quite mature after decades of development, the above-mentioned hair collection structure is basically indispensable for the cutter mesh of the rotary shaver. How to achieve a good hair collection effect, avoid hair leakage and improve shaving efficiency while ensuring both safety and comfort has become an outstanding technical problem.

In this way, the present invention is provided.

### SUMMARY OF THE INVENTION

The present invention aims to provide a simple cutter mesh structure of a rotary shaver. The cutter mesh structure achieves a desirable hair collection effect, can prevent hair leakage, has high shaving efficiency, achieves organic integration of desirable safety and comfort of shaving, and breaks through technical limitations of a cutter mesh of an existing rotary shaver.

In order to solve the above technical problems, the cutter mesh structure of the rotary shaver according to the present invention includes a cutter mesh body, the cutter mesh body is provided with a raised ring shaving track, the shaving track includes an outer ring side face, an inner ring side face, and a track top surface for connecting the outer ring side face and the inner ring side face, outer hair inlet slots and inner hair inlet slots separated from each other are provided in the shaving track, the outer hair inlet slots extend from the outer ring side face to the middle of the shaving track, the inner hair inlet slots extend from the inner ring side face to the middle of the shaving track, and there are multiple outer hair inlet slots and inner hair inlet slots which are distributed in a circumferential direction, the outer hair inlet slots and the inner hair inlet slots are staggered, and outer flared hair guide openings corresponding to the outer hair inlet slots and being used for guiding hair into the outer hair inlet slots are provided in a turning joint between the outer ring side face and the track top surface.

According to the above cutter mesh structure of the rotary shaver, inner flared hair guide openings corresponding to the inner hair inlet slots and being used for guiding hair into the inner hair inlet slots are provided in a turning joint between the inner ring side face and the track top surface.

According to the above cutter mesh structure of the rotary shaver, the inner flared hair guide openings are V-shaped openings tilting upwards, and the inner flared hair guide openings are located on two sides of the inner hair inlet slots.

According to the above cutter mesh structure of the rotary shaver, the outer flared hair guide openings are V-shaped openings tilting upwards, and the outer flared hair guide openings are located on two sides of the outer hair inlet slots.

According to the above cutter mesh structure of the rotary shaver, the outer hair inlet slots and the inner hair inlet slots are straight slots.

According to the above cutter mesh structure of the rotary shaver, each of the inner hair inlet slots extends into a middle area formed between two outer hair inlet slots corresponding to the inner hair inlet slot, so that the outer hair inlet slots and the inner hair inlet slots have overlapping areas in the circumferential direction.

According to the above cutter mesh structure of the rotary shaver, an upward concave ring shaving groove for rotary movement of a cutting edge of a rotating blade is provided in an inner top surface of the shaving track, the outer hair inlet slots extend from outside to inside beyond a center position of the shaving groove and terminate between the center position of the shaving groove and an inner groove wall of the shaving groove, and the inner hair inlet slots extend from inside to outside beyond the center position of the shaving groove and terminate between the center position of the shaving groove and an outer groove wall of the shaving groove.

According to the above cutter mesh structure of the rotary shaver, the track top surface is staggered cutting by the outer hair inlet slots, the inner hair inlet slots, the outer flared hair guide openings and the inner flared hair guide openings, reserving a continuous and complete contact surface on the track top surface for contact with skin, and the contact surface is formed by a plurality of S-shaped unit surfaces.

According to the above cutter mesh structure of the rotary shaver, the outer hair inlet slots and the inner hair inlet slots are eccentrically disposed in the shaving track.

The present invention further aims to provide a processing method of a cutter mesh structure of a rotary shaver, with a simple process.

In order to solve the above technical problems, the processing method of the cutter mesh structure of the rotary shaver includes the following steps:
A. Stamping a cutter mesh body with a raised ring shaving track;
B. Processing the shaving track with an outer slot-cutting grinding wheel, an outer edge grinding wheel, an inner slot-cutting grinding wheel, and an inner edge grinding wheel, where a thickness h1 of the outer slot-cutting grinding wheel is less than a thickness h2 of the outer edge grinding wheel, outer cutting chamfers are disposed on two sides of the outer edge grinding wheel, and the two outer cutting chamfers are in smooth transition; a thickness h3 of the inner slot-cutting grinding wheel is less than a thickness h4 of the inner edge grinding wheel, inner cutting chamfers are disposed on two sides of the inner edge grinding wheel, and the two inner cutting chamfers are in smooth transition;
   an outer hair inlet slot is cut between an outer ring side face and a track top surface of the shaving track by using the outer slot-cutting grinding wheel, the outer hair inlet slot extends from the outer ring side face to a position beyond the middle of the shaving track, a part of the material, on two sides of the outer hair inlet slot, of the cutter mesh body is cut off at a turning joint between the outer ring side face and the track top surface of the shaving track through the outer cutting chamfers on the two sides of the outer edge grinding wheel, the outer cutting chamfers are prevented from cutting through the shaving track by controlling feed of cutting, and an outer flared hair guide opening is obtained;
   an inner hair inlet slot is cut between an inner ring side face and the track top surface of the shaving track by using the inner slot-cutting grinding wheel, the inner hair inlet slot extends from the inner ring side face to a position beyond the middle of the shaving track, a part of material, on two sides of the inner hair inlet slot, of the cutter mesh body is cut off at a turning joint between the inner ring side face and the track top surface of the shaving track through the inner cutting chamfers on the two sides of the inner edge grinding wheel, the inner cutting chamfers are prevented from cutting through the shaving track by controlling the feed of cutting, and an inner flared hair guide opening is obtained; and
   a plurality of outer hair inlet slots, a plurality of inner hair inlet slots, corresponding outer flared hair guide openings and corresponding inner flared hair guide openings are cut in the shaving track in a circumferential direction, and the outer hair inlet slots and the inner hair inlet slots are separated from each other, and are staggered in the circumferential direction; and
C. Polishing edges of outer surfaces of the outer hair inlet slots, the outer flared hair guide openings, the inner hair inlet slots, and the inner flared hair guide openings.

In order to solve the above technical problems, a processing method of a cutter mesh structure of a rotary shaver includes the following steps:
A. Stamping a cutter mesh body with a raised ring shaving track, and at the same time, stamping outer flared hair guide openings and inner flared hair guide openings in the shaving track, the outer flared hair guide openings being located in a turning joint between an outer ring side face and a track top surface of the shaving track, and tilting upwards, the inner flared hair guide openings being located in a turning joint between an inner ring side face and the track top surface of the shaving track, and tilting upwards, and the plurality of outer flared hair guide openings and the plurality of inner flared hair guide openings being in one-to-one correspondence, and being staggered with one outer flared hair guide opening and one inner flared hair guide opening alternating;
B. Cutting slots in the shaving track with an outer slot-cutting grinding wheel and an inner slot-cutting grinding wheel respectively, a thickness of the outer slot-cutting grinding wheel being less than a width of the outer flared hair guide openings in a circumferential direction, a thickness of the inner slot-cutting grinding wheel being less than a width of the inner flared hair guide openings in the circumferential direction; the outer slot-cutting grinding wheel being aligned with one of the outer flared hair guide openings to cut an outer hair inlet slot between the outer ring side face and the track top surface of the shaving track, the outer hair inlet slot extending from the outer ring side face to a position beyond the middle of the shaving track; the inner slot-cutting grinding wheel being aligned with one of the inner flared hair guide openings to cut an inner hair inlet slot between the inner ring side face and the track top surface of the shaving track, the inner hair inlet slot extending from the inner ring side face to a position beyond the middle of the shaving track; a plurality outer hair inlet slots and a plurality of inner hair inlet slots corresponding to the outer flared hair guide openings and the inner flared hair guide openings respectively being cut in the shaving track in the circumferential direction; and
C. Polishing edges of outer surfaces of the outer hair inlet slots, the outer flared hair guide openings, the inner hair inlet slots, and the inner flared hair guide openings.

Compared with the prior art, the present invention has the following advantages:
1. Since the cutter mesh body of the present invention isprovided with the plurality of outer hair inlet slots and the plurality of inner hair inlet slots in a staggered manner in the circumferential direction, and the outer hair inlet slots and the inner hair inlet slots are not through slots penetrating from the outer ring side face to the inner ring side face of the shaving track, hair can enter from the outer ring side face or the inner ring side face of the shaving track, and the hair collection efficiency is high. Since the outer hair inlet slots have inner termination ends on the track top surface, and the inner hair inlet slots have outer termination ends on the track top surface, hair entering the outer hair inlet slots and the inner hair inlet slots can be prevented from running out, and hair blocked at the inner termination ends or the outer termination ends is cut off when the cutting edge rotates to the termination ends, which not only improves the shaving efficiency, but also avoids the hair being pulled and improves the comfort of shaving. Since the outer hair inlet slots and the inner hair inlet slots are staggered, while the outer hair inlet slots and the inner hair inlet slots are set to have a safe slot width to avoid skin from being squeezed into the shaving track to be cut, a spacing between every two adjacent outer hair inlet slots is extended to create a sufficient space, and with the space, the outer flared hair guide openings corresponding to the outer hair inlet slots and being used for guiding hair into the outer hair inlet slots are provided in the turning joint between the outer ring side face and the track top surface. Although the number of the outer hair inlet slots is decreased, the problem that hair is difficult to collect by an existing cutter mesh structure due to a small width of straight slots is overcome by means of the outer flared hair guide openings, and the external hair collection efficiency of the cutter mesh structure is greatly improved. In addition, after the shaving track to staggered cutting of the outer hair inlet slots and the inner hair inlet slots, the continuous and complete contact surface is reserved on the track top surface of the shaving track for contact with the skin, so that the comfort of shaving is improved, the skin feeling is enhanced, skin squeezing into the shaving track can be prevented, and skin protection is achieved.
2. Since the outer hair inlet slots and the inner hair inlet slots are staggered, while the outer hair inlet slots and the inner hair inlet slots are set to have the safe slot width to avoid the skin from being squeezed into the shaving track to be cut, a spacing between every two adjacent inner hair inlet slots is extended to create a sufficient space, and with the space, the inner flared hair guide openings corresponding to the inner hair inlet slots and being used for guiding hair into the inner hair inlet slots are provided in the turning joint between the inner ring side face and the track top surface. Thus, the hair collection efficiency of the inner hair inlet slots is improved.
3. By means of the processing method of the cutter mesh structure of the rotary shaver according to the present invention, the process is simple, and the processed cutter mesh structure has the characteristics of good hair collection effect, capacity of preventing hair leakage, high shaving efficiency, good skin protection, and good safety and comfort of shaving.

### BRIEF DESCRIPTION OF THE DRAWINGS

Specific implementations of the present invention are described in further detail below in conjunction with the accompanying drawings.

FIG. 1 is a schematic structural diagram of a cutter mesh structure of a rotary shaver according to the present invention;

FIG. 2 is a top view according to the present invention;

FIG. 3 is a sectional view in a direction A-A in FIG. 2 according to the present invention;

FIG. 4 is a bottom view according to the present invention;

FIG. 5 is a side view according to the present invention;

FIG. 6 is a schematic diagram of a contact surface reserved after slots are cut in a track top surface of a shaving track;

FIG. 7 is a schematic diagram of processing of outer hair inlet slots;

FIG. 8 is a schematic diagram of processing of outer flared hair guide openings;

FIG. 9 is a schematic diagram of processing of inner hair inlet slots;

FIG. 10 is a schematic diagram of processing of inner flared hair guide openings;

FIG. 11 is a schematic diagram of cooperation of a cutter mesh and a rotating blade;

FIG. 12 is a sectional view in a direction B-B in FIG. 11;

FIG. 13 is a partially enlarged view of C in FIG. 11; and

FIG. 14 is a schematic diagram of a cutter mesh body stamped with outer flared hair guide openings and inner flared hair guide openings.

### DETAILED DESCRIPTION OF THE INVENTION

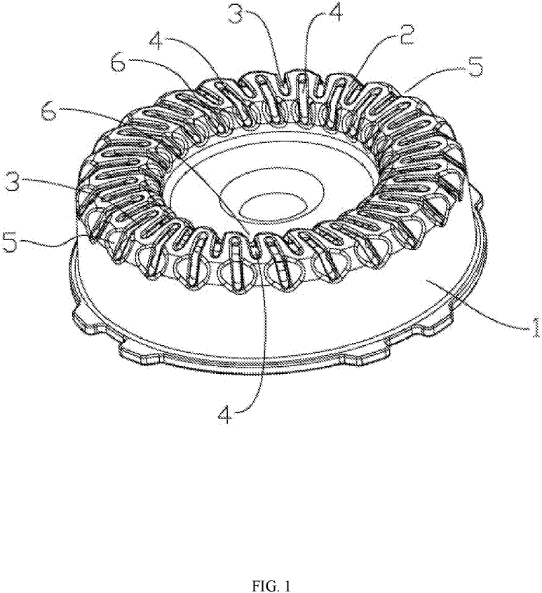

The present invention is further illustrated below in conjunction with the accompanying drawings. As shown in FIG. 1 to FIG. 6, a cutter mesh structure of a rotary shaver includes a cutter mesh body 1. The cutter mesh body 1 is provided with a raised ring shaving track 2. The shaving track 2 includes an outer ring side face 21, an inner ring side face 23, and a track top surface 22 for connecting the outer ring side face 21 and the inner ring side face 23. Outer hair inlet slots 3 and inner hair inlet slots 4 separated from each other are provided in the shaving track 2. The outer hair inlet slots 3 extend from the outer ring side face 21 to the middle of the shaving track 2, preferably, to a position beyond the middle of the shaving track 2. The inner hair inlet slots 4 extend from the inner ring side face 23 to the middle of the shaving track 2, preferably, to a position beyond the middle of the shaving track 2. There are multiple the plurality of outer hair inlet slots 3 and the plurality of inner hair inlet slots 4 which are distributed in a circumferential direction. The outer hair inlet slots 3 and the inner hair inlet slots 4 are in one-to-one correspondence in number, and are staggered with one inner hair inlet slot and one outer hair inlet slot alternating.

Preferably, the outer hair inlet slots 3 and the inner hair inlet slots 4 are evenly distributed in a circumferential direction of the shaving track 2. Of course, the outer hair inlet slots 3 and the inner hair inlet slots 4 may be distributed by 360° along the entire circumference of the shaving track 2, or the outer hair inlet slots 3 and the inner hair inlet slots 4 may be disposed alternately within a certain range of angle.

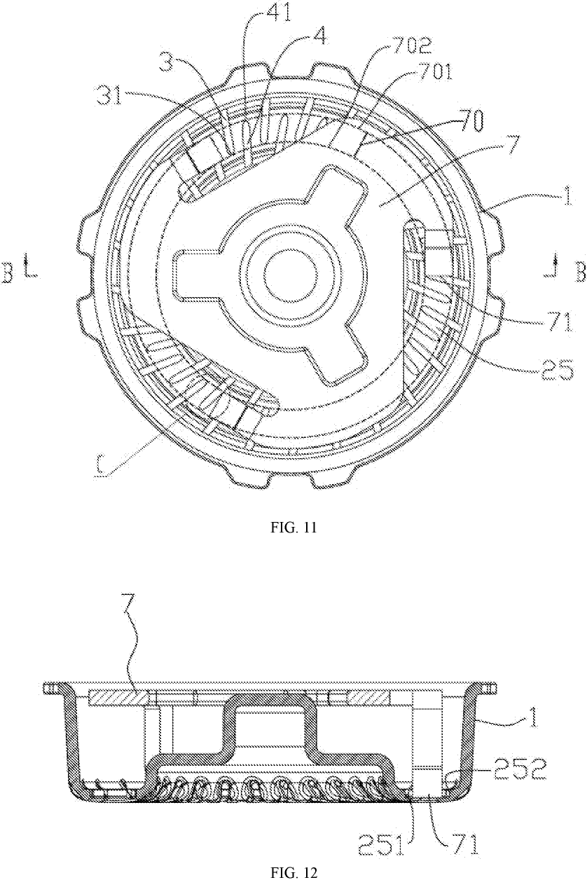

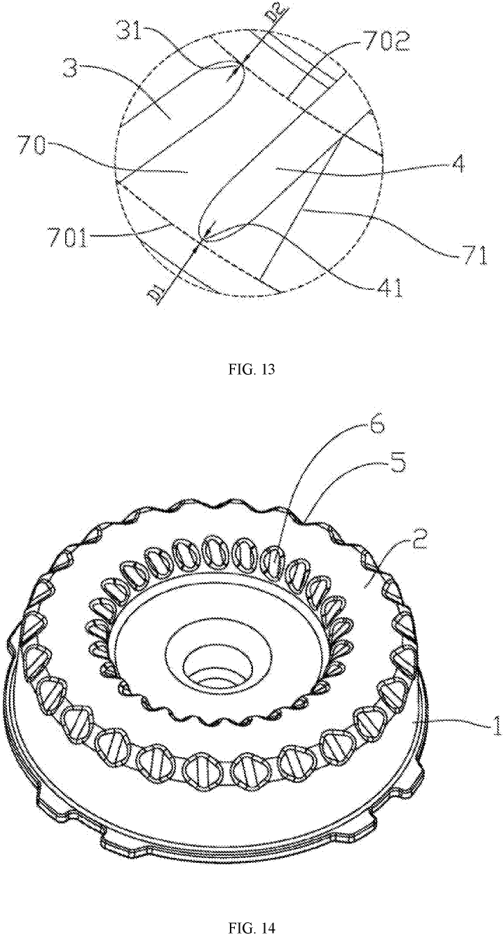

As shown in FIG. 11 to FIG. 13, when a rotating blade 7 is used for cooperation, the rotating blade 7 includes a cutting edge 71 for rotary cutting in the shaving track 2. A rotary cutting area 70 of the cutting edge 71 covers inner termination ends 31 of the outer hair inlet slots 3 on the track top surface 22, and outer termination ends 41 of the inner hair inlet slots 4 on the track top surface 22 at the same time. An outer edge 701 of the rotary cutting area 70 is formed by a rotating trajectory of an outer cutting point of the cutting edge 71. An inner edge 702 of the rotary cutting area 70 is formed by a rotating trajectory of an inner cutting point of the cutting edge 71.

Of course, in order to improve the cutting effect of the cutting edge 71 for hair at the outer termination ends 41 and the inner termination ends 31, a distance D1 between the outer edge 701 of the rotary cutting area 70 of the cutting edge 71 and the outer termination ends 41 of the inner hair inlet slots 4 on the track top surface 22, and a distance D2 between the inner edge 702 of the rotary cutting area 70 of the cutting edge 71 and the inner termination ends 31 of the outer hair inlet slots 3 on the track top surface 22 satisfy the following relation: 0 < D1 < 0.5 mm, and 0 < D2 < 0.5 mm, preferably, 0.1 mm < D1 < 0.3 mm, and 0.1 mm < D2 < 0.3 mm.

In the embodiment shown in FIG. 1 to FIG. 6, since the cutter mesh body 1 has the outer hair inlet slots 3 and the inner hair inlet slots 4, and the outer hair inlet slots 3 and the inner hair inlet slots 4 are not through slots penetrating from the outer ring side face to the inner ring side face of the shaving track, hair can enter from the outer ring side face or the inner ring side face of the shaving track, and the hair collection efficiency is high. Since the outer hair inlet slots 3 have the inner termination ends 31 on the track top surface 22, and the inner hair inlet slots 4 have the outer termination ends 41 on the track top surface 22, hair entering the outer hair inlet slots 3 and the inner hair inlet slots 4 can be prevented from running out, and hair blocked at the inner termination ends 31 or the outer termination ends 41 is cut off when the cutting edge 71 rotates to the termination ends, which not only improves the shaving efficiency, but also avoids the hair being pulled and improves the comfort of shaving.

Since the outer hair inlet slots 3 and the inner hair inlet slots 4 are staggered, while the outer hair inlet slots 3 and the inner hair inlet slots 4 are set to have a safe slot width to avoid skin from being squeezed into the shaving track to be cut, every two adjacent outer hair inlet slots 3 have a wide spacing therebetween, and with the space, outer flared hair guide openings 5 corresponding to the outer hair inlet slots 3 and being used for guiding hair into the outer hair inlet slots 3 are provided in a turning joint between the outer ring side face 21 and the track top surface 22. Although the number of the outer hair inlet slots 3 is decreased, the problem that hair is difficult to collect by an existing cutting mesh structure due to a small width of straight slots is overcome by means of the outer flared hair guide openings 5, and the external hair collection efficiency of the cutter mesh structure is greatly improved.

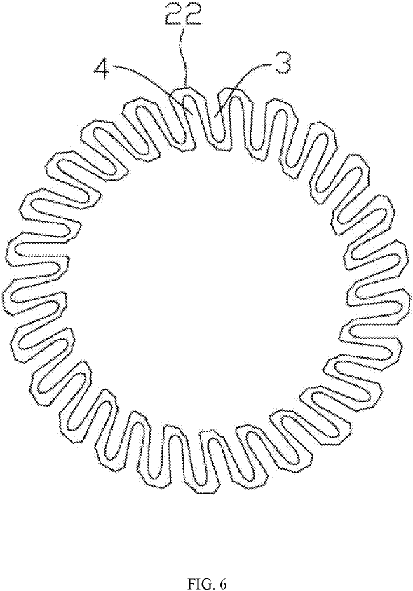

In addition, after the shaving track is staggered cutting of the outer hair inlet slots 3 and the inner hair inlet slots 4, a continuous and complete contact surface for contact with skin is reserved on the track top surface of the shaving track. As shown in FIG. 6, the track top surface is staggered cutting by the outer hair inlet slots, the inner hair inlet slots, the outer flared hair guide openings and inner flared hair guide openings, reserving the continuous and complete contact surface on the track top surface for contact with the skin, and the contact surface is defined by S-shaped unit surfaces. Thus, the comfort of shaving is improved, the skin feeling is enhanced, skin squeezing into the shaving track can be prevented, and skin protection is achieved.

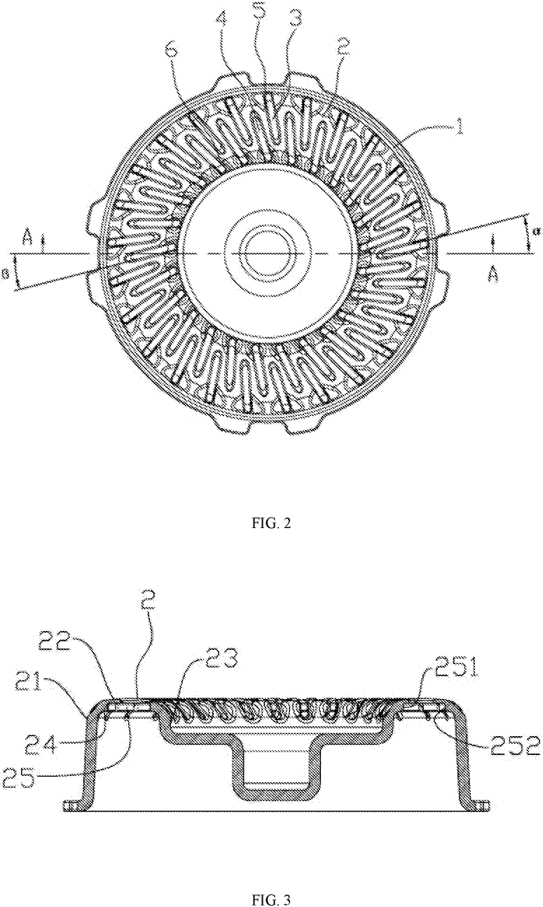

According to the embodiment shown in FIG. 2, the outer hair inlet slots 3 and the inner hair inlet slots 4 are eccentrically disposed in the shaving track 2, so that the different inner hair inlet slots 4 have a large spacing on the inner ring side face 23 to ensure that the inner hair inlet slots 4 have an appropriate width. At the same time, since the outer hair inlet slots 3 and the inner hair inlet slots 4 are eccentrically disposed in the shaving track 2, an angle α is generated between the outer hair inlet slots 3 and a radial direction, and an angle β is generated between the inner hair inlet slots 4 and the radial direction.

According to the embodiment shown in FIG. 2, since the outer hair inlet slots 3 and the inner hair inlet slots 4 are staggered, while the outer hair inlet slots 3 and the inner hair inlet slots 4 are set to have the safe slot width to avoid the skin from being squeezed into the shaving track to be cut, every two adjacent inner hair inlet slots 4 have a wide spacing therebetween, and with the space, the inner flared hair guide openings 6 corresponding to the inner hair inlet slots 4 and being used for guiding hair into the inner hair inlet slots 4 are provided in a turning joint between the inner ring side face 23 and the track top surface 22. Thus, the hair collection efficiency of the inner hair inlet slots 4 is improved.

Preferably, the outer flared hair guide openings 5 and the inner flared hair guide openings 6 are respectively V-shaped openings tilting upwards, the outer flared hair guide openings 5 are located on two sides of the outer hair inlet slots 3, and the inner flared hair guide openings 6 are located on two sides of the inner hair inlet slots 4.

As shown in FIG. 1 to FIG. 6, as an implementation of the outer hair inlet slots 3 and the inner hair inlet slots 4, the outer hair inlet slots 3 and the inner hair inlet slots 4 are straight slots which are simple in structure and convenient to process.

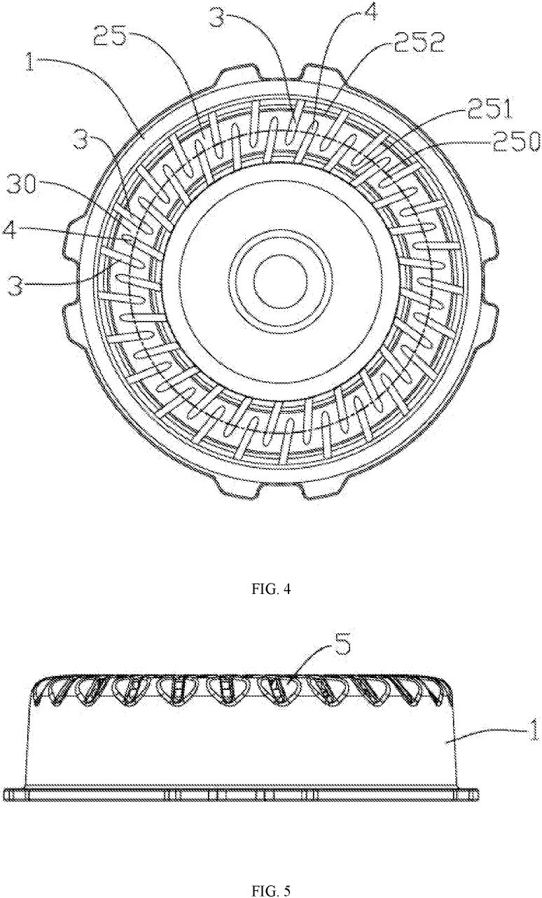

According to the embodiment shown in FIG. 4, in order to reduce the size, and ensure that the rotary cutting area 70 covers the inner hair inlet slots 4 and the outer hair inlet slots 3 by a certain depth for ensuring good cutting efficiency, each of the inner hair inlet slots 4 extends into a middle area 30 formed between two outer hair inlet slots 3 corresponding to the inner hair inlet slot, so that the outer hair inlet slots 3 and the inner hair inlet slots 4 have overlapping areas in the circumferential direction.

An upward concave ring shaving groove 25 for rotary movement of the cutting edge 71 of the rotating blade 7 is provided in an inner top surface 24 of the shaving track 2. The outer hair inlet slots 3 extend from outside to inside beyond a center position 250 of the shaving groove 25 and terminate between the center position 250 of the shaving groove 25 and an inner groove wall 251 of the shaving groove 25. The inner hair inlet slots 4 extend from inside to outside beyond the center position 250 of the shaving groove 25 and terminate between the center position 250 of the shaving groove 25 and an outer groove wall 252 of the shaving groove 25.

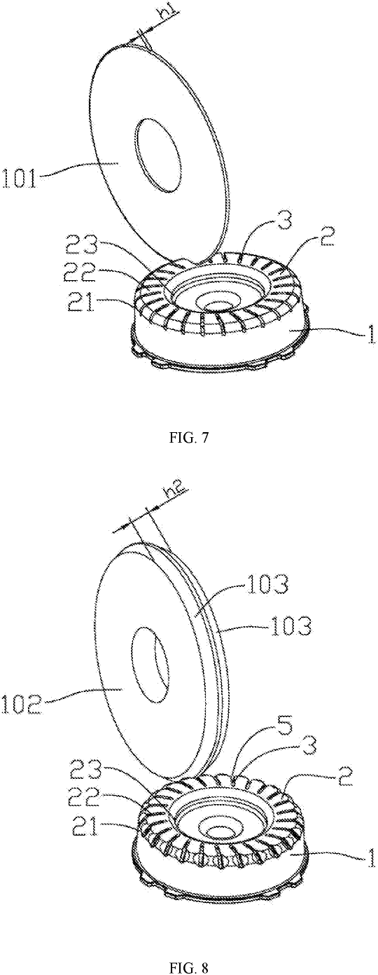

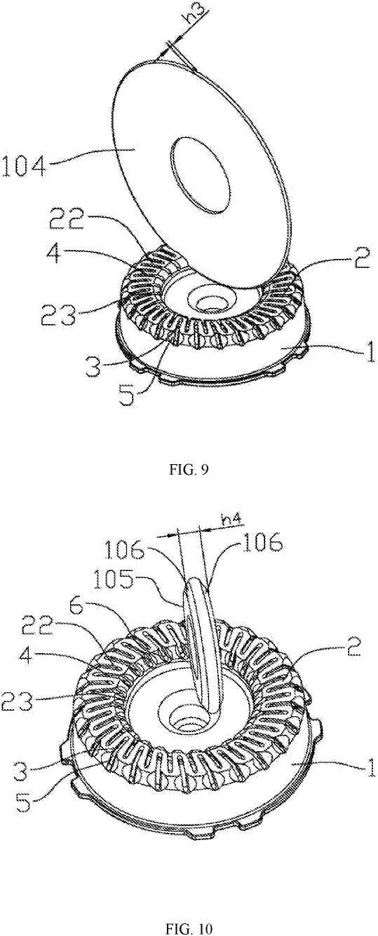

As shown in FIG. 7 to FIG. 10, a processing method for manufacturing the above cutter mesh structure of the rotary shaver includes the following steps:

A. Stamp a cutter mesh body 1 with a raised ring shaving track 2.

B. Process the shaving track 2 with an outer slot-cutting grinding wheel 101, an outer edge grinding wheel 102, an inner slot-cutting grinding wheel 104, and an inner edge grinding wheel 105. A thickness h1 of the outer slot-cutting grinding wheel 101 is less than a thickness h2 of the outer edge grinding wheel 102, outer cutting chamfers 103 are disposed on two sides of the outer edge grinding wheel 102, and the two outer cutting chamfers 103 are in smooth transition. A thickness h3 of the inner slot-cutting grinding wheel 104 is less than a thickness h4 of the inner edge grinding wheel 105, inner cutting chamfers 106 are disposed on two sides of the inner edge grinding wheel 105, and the two inner cutting chamfers 106 are in smooth transition.

An outer hair inlet slot 3 is cut between an outer ring side face 21 and a track top surface 22 of the shaving track 2 by using the outer slot-cutting grinding wheel 101, the outer hair inlet slot 3 extends from the outer ring side face 21 to a position beyond the middle of the shaving track 2, a part of material, on two sides of the outer hair inlet slot 3, of the cutter mesh body 1 is cut off at a turning joint between the outer ring side face 21 and the track top surface 22 of the shaving track 2 through the outer cutting chamfers 103 on the two sides of the outer edge grinding wheel 102,the outer cutting chamfers 103 are prevented from cutting through the shaving track 2 by controlling feed of cutting, and an outer flared hair guide opening 5 is obtained.

An inner hair inlet slot 4 is cut between an inner ring side face 23 and the track top surface 22 of the shaving track 2 by using the inner slot-cutting grinding wheel 104, the inner hair inlet slot 4 extends from the inner ring side face 23 to a position beyond the middle of the shaving track 2, a part of material, on two sides of the inner hair inlet slot 4, of the cutter mesh body 1 is cut off at a turning joint between the inner ring side face 23 and the track top surface 22 of the shaving track 2 through the inner cutting chamfers 106 on the two sides of the inner edge grinding wheel 105, the inner cutting chamfers 106 are prevented from cutting through the shaving track 2 by controlling the feed of cutting, and an inner flared hair guide opening 6 is obtained.

A plurality of outer hair inlet slots 3, a plurality of inner hair inlet slots 4, corresponding outer flared hair guide openings 5 and corresponding inner flared hair guide openings 6 are cut in the shaving track 2 in a circumferential direction, the outer hair inlet slots 3 and the inner hair inlet slots 4 are separated from each other, and the outer hair inlet slots 3 and the inner hair inlet slots 4 are staggered in the circumferential direction.

C. Polish edges of outer surfaces of the outer hair inlet slots 3, the outer flared hair guide openings 5, the inner hair inlet slots 4, and the inner flared hair guide openings 6.

In step B, during processing of the outer hair inlet slots 3, the cutter mesh body 1 retracts after processing one outer hair inlet slot 3, rotates by an angle, and feeds again to process the next outer hair inlet slot 3, and the outer flared hair guide openings 5 are processed until processing of all the outer hair inlet slots 3 is completed. After processing of all the outer flared hair guide openings 5 is completed, all the inner hair inlet slots 4 are processed in the same way, and then the inner flared hair guide openings 6 are processed at the corresponding inner hair inlet slots 4.

By means of the processing method of the cutter mesh structure of the rotary shaver, the process is simple, and the processed cutter mesh structure has the characteristics of good hair collection effect, capacity of preventing hair leakage, high shaving efficiency, good skin protection, and good safety and comfort of shaving.

The cutter mesh structure of the rotary shaver may be further processed by the following method. The method includes the following steps:

A. Stamp a cutter mesh body 1 with a raised ring shaving track 2, and at the same time, stamp outer flared hair guide openings 5 and inner flared hair guide openings 6 in the shaving track 2. The outer flared hair guide openings 5 are located in a turning joint between an outer ring side face 21 and a track top surface 22 of the shaving track 2, and tilt upwards. The inner flared hair guide openings 6 are located in a turning joint between an inner ring side face 23 and the track top surface 22 of the shaving track 2, and tilt upwards. The plurality of outer flared hair guide openings 5 and the plurality of inner flared hair guide openings 6 are in one-to-one correspondence, and are staggered with one outer flared hair guide opening and one inner flared hair guide opening alternating, as shown in FIG. 14.

B. Cut slots in the shaving track 2 with an outer slot-cutting grinding wheel 101 and an inner slot-cutting grinding wheel 104 respectively. A thickness of the outer slot-cutting grinding wheel 101 is less than a width of the outer flared hair guide openings 5 in a circumferential direction. A thickness of the inner slot-cutting grinding wheel 104 is less than a width of the inner flared hair guide openings 6 in the circumferential direction. The outer slot-cutting grinding wheel 101 is aligned with one of the outer flared hair guide openings 5 to cut an outer hair inlet slot 3 between the outer ring side face 21 and the track top surface 22 of the shaving track 2, and the outer hair inlet slot 3 extends from the outer ring side face 21 to a position beyond the middle of the shaving track 2. The inner slot-cutting grinding wheel 104 is aligned with one of the inner flared hair guide openings 6 to cut an inner hair inlet slot 4 between the inner ring side face 23 and the track top surface 22 of the shaving track 2, and the inner hair inlet slot 4 extends from the inner ring side face 23 to a position beyond the middle of the shaving track 2. A plurality outer hair inlet slots 3 and a plurality of inner hair inlet slots 4 corresponding to the outer flared hair guide openings 5 and the inner flared hair guide openings 6 respectively are cut in the shaving track 2 in the circumferential direction.

C. Polish edges of outer surfaces of the outer hair inlet slots 3, the outer flared hair guide openings 5, the inner hair inlet slots 4, and the inner flared hair guide openings 6.

By means of the processing method of the cutter mesh structure of the rotary shaver, the process is simple, and the processed cutter mesh structure has the characteristics of good hair collection effect, capacity of preventing hair leakage, high shaving efficiency, good skin protection, and good safety and comfort of shaving.

1. A cutter mesh structure of the rotary shaver, is comprising a cutter mesh body, the cutter mesh body is provided with a raised ring shaving track, the shaving track includes an outer ring side face, an inner ring side face, and a track top surface for connecting the outer ring side face and the inner ring side face, outer hair inlet slots and inner hair inlet slots separated from each other are provided in the shaving track, the outer hair inlet slots extend from the outer ring side face to the middle of the shaving track, the inner hair inlet slots extend from the inner ring side face to the middle of the shaving track, and there are multiple outer hair inlet slots and inner hair inlet slots which are distributed in a circumferential direction, the outer hair inlet slots and the inner hair inlet slots are staggered, and outer flared hair guide openings corresponding to the outer hair inlet slots and being used for guiding hair into the outer hair inlet slots are provided in a turning joint between the outer ring side face and the track top surface.

2. The cutter mesh structure of the rotary shaver according to claim 1, wherein inner flared hair guide openings corresponding to the inner hair inlet slots and being used for guiding hair into the inner hair inlet slots are provided in a turning joint between the inner ring side face and the track top surface.

3. The cutter mesh structure of the rotary shaver according to claim 2, wherein the inner flared hair guide openings are V-shaped openings tilting upwards, and the inner flared hair guide openings are located on two sides of the inner hair inlet slots.

4. The cutter mesh structure of the rotary shaver according to claim 1, wherein the outer flared hair guide openings are V-shaped openings tilting upwards, and the outer flared hair guide openings are located on two sides of the outer hair inlet slots.

5. The cutter mesh structure of the rotary shaver according to claim 1, wherein the outer hair inlet slots and the inner hair inlet slots are straight slots.

6. The cutter mesh structure of the rotary shaver according to claim 1, wherein each of the inner hair inlet slots extends into a middle area formed between two outer hair inlet slots corresponding to the inner hair inlet slot, so that the outer hair inlet slots and the inner hair inlet slots have overlapping areas in the circumferential direction.

7. The cutter mesh structure of the rotary shaver according to claim 6, wherein an upward concave ring shaving groove for rotary movement of a cutting edge of a rotating blade is provided in an inner top surface of the shaving track, the outer hair inlet slots extend from outside to inside beyond a center position of the shaving groove and terminate between the center position of the shaving groove and an inner groove wall of the shaving groove, and the inner hair inlet slots extend from inside to outside beyond the center position of the shaving groove and terminate between the center position of the shaving groove and an outer groove wall of the shaving groove.

8. The cutter mesh structure of the rotary shaver according to claim 2, wherein the track top surface is staggered cutting by the outer hair inlet slots, the inner hair inlet slots, the outer flared hair guide openings and the inner flared hair guide openings, reserving a continuous and complete contact surface on the track top surface for contact with skin, and the contact surface is formed by a plurality of S-shaped unit surfaces.

9. A processing method of the cutter mesh structure of the rotary shaver, comprising the steps of:
A. Stamping a cutter mesh body with a raised ring shaving track;
B. Processing the shaving track with an outer slot-cutting grinding wheel, an outer edge grinding wheel, an inner slot-cutting grinding wheel, and an inner edge grinding wheel, where a thickness of the outer slot-cutting grinding wheel is less than a thickness of the outer edge grinding wheel, outer cutting chamfers are disposed on two sides of the outer edge grinding wheel, and the two outer cutting chamfers are in smooth transition; a thickness of the inner slot-cutting grinding wheel is less than a thickness h4-of the inner edge grinding wheel, inner cutting chamfers are disposed on two sides of the inner edge grinding wheel, and the two inner cutting chamfers are in smooth transition;
an outer hair inlet slot is cut between an outer ring side face and a track top surface of the shaving track by using the outer slot-cutting grinding wheel, the outer hair inlet slot extends from the outer ring side face to a position beyond the middle of the shaving track, a part of the material, on two sides of the outer hair inlet slot, of the cutter mesh body is cut off at a turning joint between the outer ring side face and the track top surface of the shaving track through the outer cutting chamfers on the two sides of the outer edge grinding wheel, the outer cutting chamfers are prevented from cutting through the shaving track by controlling feed of cutting, and an outer flared hair guide opening is obtained;
an inner hair inlet slot (4)-is cut between an inner ring side face and the track top surface of the shaving track by using the inner slot-cutting grinding wheel, the inner hair inlet slot extends from the inner ring side face to a position beyond the middle of the shaving track, a part of material, on two sides of the inner hair inlet slot, of the cutter mesh body is cut off at a turning joint between the inner ring side face and the track top surface of the shaving track through the inner cutting chamfers on the two sides of the inner edge grinding wheel, the inner cutting chamfers are prevented from cutting through the shaving track by controlling the feed of cutting, and an inner flared hair guide opening is obtained; and
a plurality of outer hair inlet slots, a plurality of inner hair inlet slots, corresponding outer flared hair guide openings and corresponding inner flared hair guide openings are cut in the shaving track in a circumferential direction, and the outer hair inlet slots and the inner hair inlet slots are separated from each other, and are staggered in the circumferential direction; and
C. Polishing edges of outer surfaces of the outer hair inlet slots, the outer flared hair guide openings, the inner hair inlet slots, and the inner flared hair guide openings.

10. A processing method of the cutter mesh structure of the rotary shaver, comprising the steps of:
A. Stamping a cutter mesh body with a raised ring shaving track, and at the same time, stamping outer flared hair guide openings and inner flared hair guide openings in the shaving track, the outer flared hair guide openings being located in a turning joint between an outer ring side face and a track top surface of the shaving track, and tilting upwards, the inner flared hair guide openings being located in a turning joint between an inner ring side face and the track top surface of the shaving track, and tilting upwards, and the plurality of outer flared hair guide openings and the plurality of inner flared hair guide openings being in one-to-one correspondence, and being staggered with one outer flared hair guide opening and one inner flared hair guide opening alternating;
B. Cutting slots in the shaving track with an outer slot-cutting grinding wheel and an inner slot-cutting grinding wheel respectively, a thickness of the outer slot-cutting grinding wheel being less than a width of the outer flared hair guide openings in a circumferential direction, a thickness of the inner slot-cutting grinding wheel being less than a width of the inner flared hair guide openings in the circumferential direction; the outer slot-cutting grinding wheel being aligned with one of the outer flared hair guide openings to cut an outer hair inlet slot between the outer ring side face and the track top surface of the shaving track track, the outer hair inlet slot extending from the outer ring side face to a position beyond the middle of the shaving track track; the inner slot-cutting grinding wheel being aligned with one of the inner flared hair guide openings to cut an inner hair inlet slot between the inner ring side face and the track top surface of the shaving track track, the inner hair inlet slot extending from the inner ring side face to a position beyond the middle of the shaving track track; a plurality outer hair inlet slots and a plurality of inner hair inlet slots corresponding to the outer flared hair guide openings and the inner flared hair guide openings respectively being cut in the shaving track in the circumferential direction; and
C. Polishing edges of outer surfaces of the outer hair inlet slots, the outer flared hair guide openings, the inner hair inlet slots, and the inner flared hair guide openings.
